(19) United States
(12) Patent Application Publication
(10) Pub. No.: US 2016/0239994 A1
(43) Pub. Date: Aug. 18, 2016

(54) METHOD OF RAY TRACING, APPARATUS PERFORMING THE SAME AND STORAGE MEDIA STORING THE SAME

(71) Applicant: SILICONARTS INC., Songpa-gu Seoul (KR)

(72) Inventors: Woo Nam CHUNG, Anyang-si Gyeonggi-do (KR); Byoung Ok LEE, Seongnam-si Gyeonggi-do (KR)

(21) Appl. No.: 14/379,515

(22) PCT Filed: Aug. 18, 2014
(86) PCT No.: PCT/KR2014/007641

§ 371 Date: Dec. 22, 2014

(51) Int. Cl. G06T 15/06; G06T 15/50

(52) U.S. Cl. CPC G06T 15/06; G06T 15/50; G06T 2210/61; G06T 2200/04

(57) ABSTRACT

This application relates to a ray tracing apparatus and the apparatus includes a main ray tracing unit configured to generate an acceleration structure (AS) and configured to transmit scene data to perform a ray tracing operation for a part of the scene data and a plurality of sub ray tracing units being coupled in series, each except for a last sub ray tracing unit configured to relay the scene data to a next sub ray tracing unit and configured to perform a ray tracing operation on a different part of the scene data. Therefore, the ray tracing apparatus may include a plurality of chips to process a rendering for a 3-dimensional image in real time.

### TECHNICAL FIELD

This application relates to a ray tracing technology and more particularly to a method of ray tracing, an apparatus performing the same and a storage medium storing the same including a plurality of chips processing a ray tracing to process a rendering for a 3-dimensional image in real time.

### BACKGROUND ART

A 3-dimentional graphic technology is a graphic technology using a 3-dimentional expression of geometric data stored in a computing and is widely used in various industries including a media industry and a game industry. In general, the 3-dimentional graphic technology additionally requires a high performance graphic processor by many computational quantities. Specially, a ray tracing technology generating an actual 3-dimensional graphic is researched according to a recent development of a processor.

The ray tracing technology corresponds to a rendering method according to a global illumination and may generate a realistic 3D image. This is because a reflection, refraction and shadow effect is naturally provided by considering an influence that a light reflected or refracted by another object influences on an image of a present object.

Korean Patent Publication No. 10-2010-0077423 relates to an apparatus and a method for enhancing ray tracing speed based on a secondary ray grouped based on a direction on a 3-dimencsion space of the secondary ray. This technology may enhance a ray tracing performance by grouping the secondary ray based on a primary ray.

Korean Patent Publication No. 10-2011-0059037 relates to a ray tracing apparatus and method using a multi-level kernel in order to perform to a common operation for all pixels and to generate a new kernel for a pixel that an additional ray is generated to perform an additional operation.

### Technical Problem

Example embodiments of the present invention propose a ray tracing apparatus capable of including a plurality of chips processing a ray tracing operation to process a rendering for a 3-dimensional image in real time.

Example embodiments of the present invention propose a ray tracing apparatus capable of receiving same scene data from each of a plurality of chips to perform a ray tracing operation for a corresponding scene.

Example embodiments of the present invention propose a ray tracing apparatus capable of separately operating an interface associated with each of a plurality of chips to prevent a conflict in an operation between the interfaces.

### Technical Solution

In some embodiments, a ray tracing apparatus includes a main ray tracing unit configured to generate an acceleration structure (AS) and configured to transmit scene data to perform a ray tracing operation for a part of the scene data and a plurality of sub ray tracing units being coupled in series, each except for a last sub ray tracing unit configured to relay the scene data to a next sub ray tracing unit and configured to perform a ray tracing operation on a different part of the scene data.

In one embodiment, the main ray tracing unit may divide the scene data to respectively provide the divided scene data to the plurality of sub ray tracing units.

The main ray tracing unit also transmits division information for the scene data and provision information for a corresponding sub ray tracing unit when the main ray tracing unit transmits the scene data. The main ray tracing unit may also transmit the acceleration structure (AS) when the main ray tracing unit transmits the scene data.

In one embodiment, the main ray tracing unit may transmit a ray tracing partial image generated according to the ray tracing operation among a first one of the plurality of sub ray tracing units.

The first sub ray tracing unit may combine a first ray tracing partial image generated according to the ray tracing with other ray tracing partial image received from the main ray tracing unit to transmit the combined image to a next sub ray tracing unit.

At least one second sub ray tracing unit except for first and last sub ray tracing units may combine a second ray tracing partial image generated according to a ray tracing operation and a ray tracing partial image received from a previous sub ray tracing unit to transmit the combined image to a next sub ray tracing unit.

In one embodiment, a last sub ray tracing unit may combine a ray tracing partial image generated by a ray tracing operation and other ray tracing partial image received from a previous sub ray tracing unit to generate a final ray tracing image.

The main ray tracing unit and the plurality of sub ray tracing units may transmit or relay the scene data and then perform the ray tracing operation.

In one embodiment, the apparatus may further include a display unit configured to receive the final ray tracing image from the last sub ray tracing unit to display the final lay tracing image.

The apparatus may further include a plurality of memory units respectively coupled to the main ray tracing unit and the plurality of sub ray tracing units, each storing the acceleration structure (AS) and the scene data.

In some embodiments, a ray tracing method being performed on the ray tracing apparatus including a main ray tracing unit and a plurality of sub ray tracing units being coupled in series and the method includes generating an acceleration structure (AS) through the main ray tracing unit and transmitting scene data to perform a ray tracing operation for a part of the scene data and relaying the scene data to a next sub ray tracing unit through each except for a last sub ray tracing unit and performing the ray tracing operation for a different part of the scene data.

In one embodiment, the method may further include receiving the final ray tracing image from the last sub ray tracing unit to display the final ray tracing image.

The method may further include respectively coupling to the main tracing unit and the plurality of sub ray tracing units to respectively store the acceleration structure (AS) and the scene data.

In some embodiments, a machine-readable non-transitory medium storing a computer program for a ray tracing method, the method being performed on a ray tracing apparatus including a main ray tracing unit and a plurality of sub ray tracing units being coupled in series, the machine-readable non-transitory medium having stored thereon machine-executable include instructions for generating an acceleration structure(AS) through the main ray tracing unit and transmitting scene data to perform a ray tracing operation for a part of the scene data and relaying the scene data to a next sub ray tracing unit through each except for a last sub ray tracing unit and performing the ray tracing operation for a different part of the scene data.

### Technical Effects

A ray tracing apparatus according to example embodiments of the present invention may include a plurality of chips processing a ray tracing operation to process a rendering for a 3-dimensional image in real time.

A ray tracing apparatus according to example embodiments of the present invention may receive same scene data from each of a plurality of chips to perform a ray tracing operation for a corresponding scene.

A ray tracing apparatus according to example embodiments of the present invention may separately operate an interface associated with each of a plurality of chips to prevent a conflict in an operation between the interfaces.

### DESCRIPTION OF DRAWINGS

FIG. 1 is a block diagram illustrating a ray tracing apparatus according to an example embodiment of the present invention.

FIG. 2 is a flow chart illustrating a ray tracing procedure being performed on a main ray tracing unit of a ray tracing apparatus in FIG. 1.

FIG. 3 is a flow chart illustrating a ray tracing procedure being performed on a sub ray tracing unit of a ray tracing apparatus in FIG. 1.

FIG. 4 is a flow chart illustrating a ray tracing procedure being performed on a ray tracing apparatus in FIG. 1.

FIG. 5 is an example diagram illustrating a scene data division being performed on a ray tracing apparatus in FIG. 1.

### MODE FOR INVENTION

The embodiments and the configurations depicted in the drawings are illustrative purposes only and do not represent all technical scopes of the invention, so it should be understood that various equivalents and modifications may exist at the time of filing this application. Although a preferred embodiment of the disclosure has been described for illustrative purposes, those skilled in the art will appreciate that various modifications, additions and substitutions are possible, without departing from the scope and spirit of the invention as disclosed in the accompanying claims.

Terms and words used in the specification and the claims shall be interpreted as to be relevant to the technical scope of the invention based on the fact that the inventor may property define the concept of the terms to explain the invention in best ways.

The terms “first” and “second” can be used to refer to various components, but the components may not be limited to the above terms. The terms will be used to discriminate one component from the other component. For instance, the first component may be referred to the second component and vice versa without departing from the right of the disclosure.

When a component is referred to as being “connected to” or “linked to” another component, the component may be directly connected to or linked to another component or an intervening component may be present therebetween. In contrast, if a component is referred to as being “directly connected to” or “directly linked to” another component, an intervening component may not be present therebetween.

The terms used in the specification are for the purpose of explaining specific embodiments and have no intention to limit the disclosure. Unless the context indicates otherwise, the singular expression may include the plural expression. In the following description, the term “include” or “has” will be used to refer to the feature, the number, the step, the operation, the component, the part or the combination thereof without excluding the presence or addition of one or more features, the numbers, the steps, the operations, the components, the parts or the combinations thereof.

Identification letters (e.g., a, b, c, etc.) in respective steps or operations are used for the sake of explanation and do not describe any particular order. The respective operations may be changed from a mentioned order unless specifically mentioned in context. Namely, respective steps may be performed in the same order as described, may be substantially simultaneously performed, or may be performed in reverse order.

The present invention may be implemented as machine-readable codes on a machine-readable medium. The machine-readable medium includes any type of recording device for storing machine-readable data. Examples of the machine-readable recording medium include a read-only memory (ROM), a random access memory (RAM), a compact disk-read only memory (CD-ROM), a magnetic tape, a floppy disk, and optical data storage. The medium may also be carrier waves (e.g.,

Internet transmission). The computer-readable recording medium may be distributed among networked machine systems which store and execute machine-readable codes in a de-centralized manner.

The terms used in the present application are merely used to describe particular embodiments, and are not intended to limit the present invention. Unless otherwise defined, all terms used herein, including technical or scientific terms, have the same meanings as those generally understood by those with ordinary knowledge in the field of art to which the present invention belongs. Such terms as those defined in a generally used dictionary are to be interpreted to have the meanings equal to the contextual meanings in the relevant field of art, and are not to be interpreted to have ideal or excessively formal meanings unless clearly defined in the present application.

This application is a result material being supported through Seoul Business Agency 2013 └commercialization support business for patented technology┘. This commercialization support business is processed for “software kit development for developing ray tracing rendering contents (project No. PA130017)”

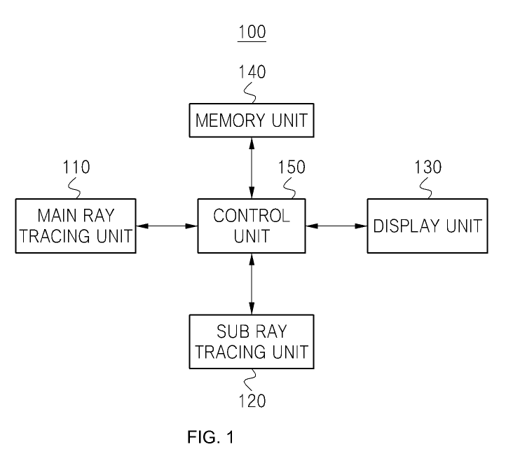

FIG. 1 is a block diagram illustrating a ray tracing apparatus according to an example embodiment of the present invention.

Referring to FIG. 1, the ray tracing apparatus 100 includes a main ray tracing unit 110, a plurality of sub ray tracing units 120, a display unit 130, a memory unit 140 and a control unit 150.

The main ray tracing unit 110 is formed of a single chip and generates an acceleration structure (AS). The acceleration structure includes kd-tree (k-depth tree) or BVH (Bounding Volume Hierarchy) being generally used for the ray tracing operation. The main ray tracing unit 110 may be coupled to the plurality of sub ray tracing units 120. That is, a single main chip may be coupled to a plurality of chips.

Hereinafter, it is assumed that the acceleration structure (AS) uses the kd-tree. The kd-tree is a kind of a spatial partitioning tree and is used for a ray-triangle intersection test. The kd-tree includes a box node, an inner node and a leaf node and the leaf node includes a triangle list for pointing information of at least one triangle included in geometric data. In one embodiment, when the triangle information included in the geometric data is implemented as an array, the triangle list included in the leaf node may correspond to an array index. The geometric data include information of a triangle (hereinafter, referred to as triangle information) for the ray tracing. In one embodiment, the triangle information may include a texture coordinate and a normal vector for 3 point of the triangle.

The main ray tracing unit 110 transmits scene data and performs a ray tracing operation for a part of the scene data. The scene data include information for a pixel of each of scenes. An operation for each of the pixels of the scene data may be separately performed. The main ray tracing unit 110 may transmit the scene data to a first sub ray tracing unit 120 and then may perform the ray tracing operation.

The main ray tracing unit 110 may be coupled to the first sub ray tracing unit 120 in series to also transmit the acceleration structure to the first sub ray tracing unit 120 when the main ray tracing unit 110 transmits the scene data to the first sub ray tracing unit 120.

The main ray tracing unit 110 may divide the scene data to respectively provide the divided scene data to the plurality of sub ray tracing units 120. The main ray tracing unit 110 may divide the scene data according to a scene resolution. The divided scene data may be respectively provided the plurality of sub ray tracing units 120. For example, the main ray tracing unit 110 may divide the scene data into 10 according to the scene resolution to respectively provide each of divided 10 scene data to the plurality of sub ray tracing units 120.

The main ray tracing unit 110 may transmit division information of the scene data and provision information for a corresponding sub ray tracing unit 120 when the main ray tracing unit 110 transmits the scene data. In one embodiment, the division information of the scene data may correspond to a unique address corresponding to divided scene data and the provision information for the corresponding sub ray tracing unit 120 may correspond to a chip number associated with the corresponding sub ray tracing unit 120.

The main ray tracing unit 110 may be coupled to the memory unit 140 to perform the ray tracing operation by using information stored in the memory unit 140. In one embodiment, the main ray tracing unit 110 may receive a different ray tracing partial image combined from a last sub ray tracing unit 120 to generate a final ray tracing image. The main ray tracing unit 110 may be coupled to the display unit 130 to transmit the final ray tracing image.

The main ray tracing unit 110 may transmit a ray tracing partial image generated by a performance of the ray tracing operation to the first sub ray tracing unit 120. The main ray tracing unit 110 may transmit the ray tracing partial image to the first sub ray tracing unit 120 to store the ray tracing partial image in the memory unit 140.

In one embodiment, the main ray tracing unit 110 may be coupled to the first sub ray tracing unit 120 through In-Out interface to share the scene data and the acceleration structure with the first sub ray tracing unit 120.

The plurality of sub ray tracing units 120 is a plurality of chips and is coupled in series each other. The plurality of sub ray tracing units 120 may be coupled to two different sub ray tracing units 120. Each except for a last sub ray tracing unit 120 relays the scene data to a next sub ray tracing unit 120 and perform a ray tracing operation a different part of the scene data. The plurality of sub ray tracing units 120 may transmit the scene data to a next sub ray tracing unit 120 and then may perform a ray tracing operation. Each except for a last sub ray tracing unit 120 may also transmit the acceleration structure when a corresponding sub ray tracing unit 120 transmits the scene data.

The first sub ray tracing unit 120 may combine a different ray tracing partial image generated according to the ray tracing operation performed based on the scene data and a ray tracing partial image received from the main ray tracing unit 110 to transmit the combined ray tracing image to a next sub ray tracing unit 120. The first sub ray tracing unit 120 may store the combined ray tracing image in a memory unit 140 coupled to the first sub ray tracing unit 120.

At least one second sub ray tracing unit except for first and last sub ray tracing units 120 may combine a different ray tracing partial image generated a ray tracing operation performed based on the scene data and a different ray tracing partial image received from a previous sub ray tracing image 120 to transmit the combined ray tracing image to a next sub ray tracing unit 120. The at least one second sub ray tracing unit except for first and last sub ray tracing units 120 may store the combined ray tracing image in a memory unit 140 respectively coupled to the at least one second sub ray tracing unit except for first and last sub ray tracing units 120.

The last sub lay tracing unit 120 may combine a different ray tracing partial image generated according to a ray tracing operation performed based on the scene data and a different ray tracing partial image received from a previous sub ray tracing unit 120 to generate the final ray tracing image. The last sub lay tracing unit 120 may compress the final ray tracing image to transmit the final ray tracing image to the display unit 130.

The plurality of sub ray tracing units 120 may be respectively coupled to the memory unit 140 to perform the ray tracing operation by using information stored in the memory unit 140.

In one embodiment, the plurality of sub ray tracing units 120 is coupled to each other through the In-Out interface to share the scene data and the acceleration structure.

The display unit 130 may receive the final ray tracing image from the last sub ray tracing unit 120 to display the final ray tracing image. In one embodiment, the display unit 130 may receive the final ray tracing image from the main ray tracing unit 110.

When the display unit 130 receives the compressed final ray tracing image from the last sub ray tracing unit 120, the display unit 130 may decode the final ray tracing image to display the decoded final ray tracing image.

The memory unit 140 is respectively coupled the main ray tracing unit 110 and the plurality of sub ray tracing units 120 and stores the acceleration structure and the scene data. In one embodiment, the memory unit 140 may be implemented as DRAM (Dynamic Random Access Memory).

The control unit 150 may control all operation of the ray tracing apparatus 100 and may control a control flow or data flow among the main ray tracing unit 110, the plurality of sub ray tracing units 120, the display unit 130 and the memory unit 140.

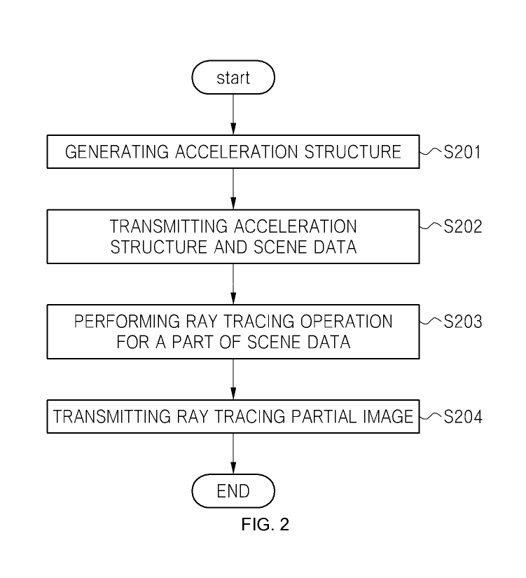

FIG. 2 is a flow chart illustrating a ray tracing procedure being performed on a main ray tracing unit of a ray tracing apparatus in FIG. 1.

Referring to FIG. 2, the main ray tracing unit 110 generates the acceleration structure (AS) (Step S201).

The main ray tracing unit 110 transmits the acceleration structure and the scene data (Step S202).

The main ray tracing unit 110 may be coupled to the first sub ray tracing unit 120 in series to also transmit the acceleration structure when the main tracing unit 110 transmits the scene data to the first sub ray tracing unit 120.

The main tracing unit 110 performs a ray tracing operation on a part of the scene data (Step S203).

The main tracing unit 110 transmits a ray tracing partial image generated according to a performance of a ray tracing operation to the first sub ray tracing unit 120 (Step S204).

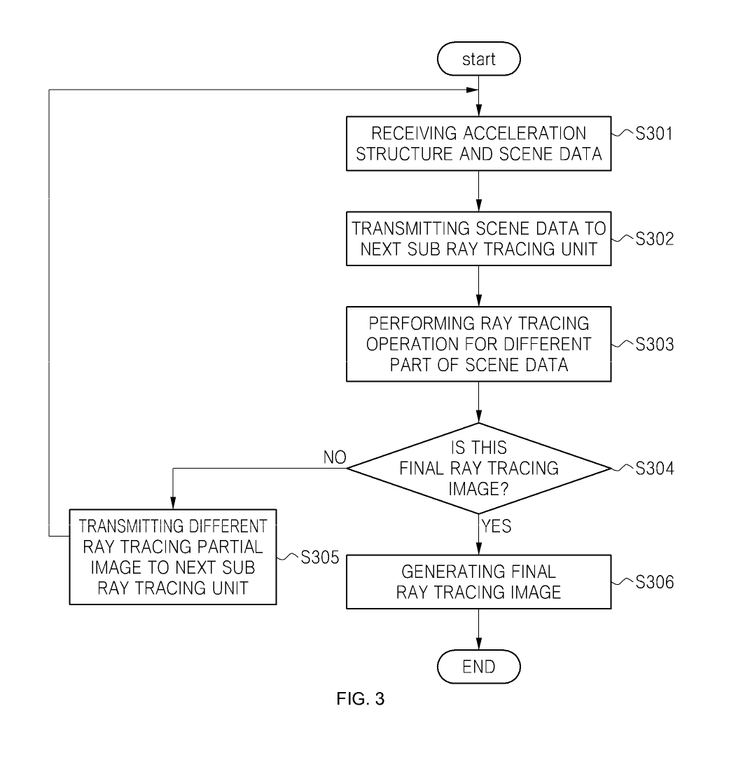

FIG. 3 is a flow chart illustrating a ray tracing procedure being performed on a sub ray tracing unit of a ray tracing apparatus in FIG. 1.

Referring to FIG. 3, the first sub ray tracing unit 120 receives the acceleration structure and the scene data form the main ray tracing unit 110 (Step S301).

The plurality of sub ray tracing units 120 relays the scene data to a next sub ray tracing unit (Step S302).

The plurality of sub ray tracing units 120 performs a ray tracing operation on a different part of the scene data (Step S303).

When a corresponding sub ray tracing unit 120 is not the last sub ray tracing unit 120, the plurality of sub ray tracing units 120 combines a different ray tracing partial image generated according to a ray tracing operation performed based on the scene data and a different ray tracing partial image received from a previous sub ray tracing unit to transmit the combined image to a next sub ray tracing unit (Steps S304 and S305).

When a corresponding sub ray tracing unit 120 is the last sub ray tracing unit, the last sub ray tracing unit 120 combines a different ray tracing partial image generated according to a ray tracing operation performed based on the scene data and a different ray tracing partial image received from a previous sub ray tracing unit 120 to generate the final ray tracing image (Steps S304 and S306).

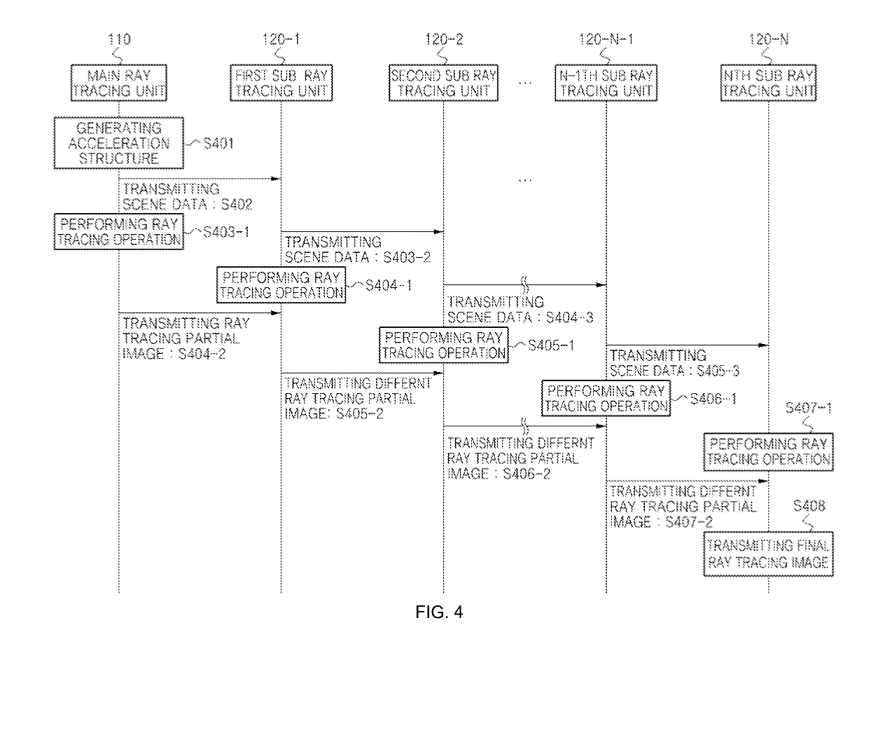

FIG. 4 is a flow chart illustrating a ray tracing procedure being performed on a ray tracing apparatus in FIG. 1.

Referring to FIG. 4, the main ray tracing unit 110 generates the acceleration structure (AS) (Step S401).

The main ray tracing unit 110 transmits the scene data to a first sub ray tracing unit 120-1 (that is, a first of the plurality of sub ray tracing units 120) (Step S402).

The main ray tracing unit 110 transmits the scene data and then performs a ray tracing operation (Step S403-1).

While the main ray tracing unit 110 performs a ray tracing operation, the first sub ray tracing unit 120-1 transmits the scene data to a second sub ray tracing unit 120-2 (Step S403-2).

The first sub ray tracing unit 120-1 transmits the scene data and then performs a ray tracing operation on the scene data (Step S404-1).

The main ray tracing unit 110 transmits a ray tracing partial image generated according to a ray tracing operation to the first sub ray tracing unit 120-1 when the first sub ray tracing unit 120-1 performs the ray tracing operation (Step S404-2).

While the first sub ray tracing unit 120-1 performs the ray tracing operation, a second sub ray tracing unit 120-2 transmits the scene data to a third sub ray tracing unit (not shown) (Step S404-3).

The second sub ray tracing unit 120-2 transmits the scene data and then performs a ray tracing operation on the scene data (Step S405-1).

When the second sub ray tracing unit 120-2 performs a ray tracing operation, the first sub ray tracing unit 120-1 combines a different ray tracing partial image generated according to a ray tracing operation and a ray tracing partial image received from the main ray tracing unit 110 to transmit the combined image to the second sub ray tracing unit 120-2 (Step S405-2).

When the third sub ray tracing unit (not shown) performs the ray tracing operation, the second sub ray tracing unit 120-2 combines a different ray tracing partial image generated according to a ray tracing operation and a different ray tracing partial image received from the first sub ray tracing unit 120-1 to transmit the combined image to the third sub ray tracing unit (not shown) (Step S406-2).

While a N-2th sub ray tracing unit (not shown) performs a ray tracing operation, a N-1th sub ray tracing unit 120-N-1 transmits the scene data to a Nth sub ray tracing unit (120-N) (Step S405-3).

The N-1th sub ray tracing unit 120-N-1 transmits the scene data and then performs a ray tracing operation on the scene data (Step S406-1).

When the N-1th sub ray tracing unit 120-N-1 performs a ray tracing operation, the N-1th sub ray tracing unit 120-N-1 receives a different ray tracing partial image generated according to a ray tracing operation from the N-2th sub ray tracing unit (not shown).

The Nth sub ray tracing unit 120-N performs a ray tracing operation for the scene data (Step S407-1).

When the Nth sub ray tracing unit 120-N performs the ray tracing operation, the N-1th sub ray tracing unit 120-N-1 combines a different ray tracing partial image generated according to a ray tracing operation and a different ray tracing partial image received from the N-2th sub ray tracing unit (not shown) to transmit the combined image to the Nth sub ray tracing unit 120-N (Step S407-2).

The Nth sub ray tracing unit 120-N combines a different ray tracing partial image generated according to a ray tracing operation and a different ray tracing partial image received from the N-1th sub ray tracing unit 120-N-1 to generate the final ray tracing image (Step S408).

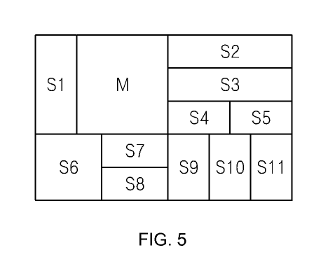

FIG. 5 is an example diagram illustrating a scene data division being performed on a ray tracing apparatus in FIG. 1.

Referring to FIG. 5, the main ray tracing unit 110 may divides the scene data and may provide each of the divided scene data to one of the plurality of sub ray tracing units 120. The plurality of sub ray tracing units 120 may receive the division information of the scene data and the provision information for a corresponding sub ray tracing unit 120 from the main ray tracing unit 110 and a previous sub ray tracing unit 120 to perform a ray tracing operation for a corresponding scene data.

M indicates the main ray tracing unit 110, 51 indicates a first sub ray tracing unit, . . . , S11 indicates a last sub ray tracing unit.

Although embodiments have been described with reference to a number of illustrative embodiments thereof, it should be understood that numerous other modifications and embodiments can be devised by those skilled in the art that will fall within the spirit and scope of the principles of this disclosure.

1. A ray tracing apparatus comprising:
a main ray tracing unit configured to generate an acceleration structure (AS) and configured to transmit scene data to perform a ray tracing operation for a part of the scene data; and
a plurality of sub ray tracing units being coupled in series, each except for a last sub ray tracing unit configured to relay the scene data to a next sub ray tracing unit and configured to perform a ray tracing operation on a different part of the scene data.

2. The apparatus of claim 1, wherein the main ray tracing unit divides the scene data to respectively provide the divided scene data to the plurality of sub ray tracing units.

3. The apparatus of claim 2, wherein the main ray tracing unit also transmits division information for the scene data and provision information for a corresponding sub ray tracing unit when the main ray tracing unit transmits the scene data.

4. The apparatus of claim 2, wherein the main ray tracing unit also transmits the acceleration structure (AS) when the main ray tracing unit transmits the scene data.

5. The apparatus of claim 1, wherein the main ray tracing unit transmits a ray tracing partial image generated according to the ray tracing operation among a first one of the plurality of sub ray tracing units.

6. The apparatus of claim 5, wherein the first sub ray tracing unit combines a first ray tracing partial image generated according to the ray tracing with other ray tracing partial image received from the main ray tracing unit to transmit the combined image to a next sub ray tracing unit.

7. The apparatus of claim 6, wherein at least one second sub ray tracing unit except for first and last sub ray tracing units combines a second ray tracing partial image generated according to a ray tracing operation and a ray tracing partial image received from a previous sub ray tracing unit to transmit the combined image to a next sub ray tracing unit.

8. The apparatus of claim 7, wherein a last sub ray tracing unit combines a ray tracing partial image generated by a ray tracing operation and other ray tracing partial image received from a previous sub ray tracing unit to generate a final ray tracing image.

9. The apparatus of claim 1, wherein the main ray tracing unit and the plurality of sub ray tracing units transmit or relay the scene data and then perform the ray tracing operation.

10. The apparatus of claim 1, further comprising:
a display unit configured to receive the final ray tracing image from the last sub ray tracing unit to display the final lay tracing image.

11. The apparatus of claim 1, further comprising:
a plurality of memory units respectively coupled to the main ray tracing unit and the plurality of sub ray tracing units, each storing the acceleration structure (AS) and the scene data.

12. A ray tracing method being performed on the ray tracing apparatus including a main ray tracing unit and a plurality of sub ray tracing units being coupled in series, the method comprising:
generating an acceleration structure (AS) through the main ray tracing unit and transmitting scene data to perform a ray tracing operation for a part of the scene data; and
relaying the scene data to a next sub ray tracing unit through each except for a last sub ray tracing unit and performing the ray tracing operation for a different part of the scene data.

13. The method of claim 12, further comprising:
receiving the final ray tracing image from the last sub ray tracing unit to display the final ray tracing image.

14. The method of claim 12, further comprising:
respectively coupling to the main tracing unit and the plurality of sub ray tracing units to respectively store the acceleration structure (AS) and the scene data.

15. A machine-readable non-transitory medium storing a computer program for a ray tracing method, the method being performed on a ray tracing apparatus including a main ray tracing unit and a plurality of sub ray tracing units being coupled in series, the machine-readable non-transitory medium having stored thereon machine-executable instructions for:
generating an acceleration structure(AS) through the main ray tracing unit and transmitting scene data to perform a ray tracing operation for a part of the scene data; and
relaying the scene data to a next sub ray tracing unit through each except for a last sub ray tracing unit and performing the ray tracing operation for a different part of the scene data.
